(19) United States
(12) Patent Application Publication
(10) Pub. No.: US 2024/0010358 A1
(43) Pub. Date: Jan. 11, 2024

(54) RAPID RE-DIRECTIONAL TWO-WAY CONCURRENT TILT LIFT MODULE SYSTEM

(71) Applicant: Craig Walden Grass, Seattle, WA (US)

(72) Inventor: Craig Walden Grass, Seattle, WA (US)

(21) Appl. No.: 18/131,335

(22) Filed: Apr. 5, 2023

Related U.S. Application Data
(60) Provisional application No. 63/358,754, filed on Jul. 6, 2022.

(51) Int. Cl. B64F 5/10

(52) U.S. Cl. CPC B64F 5/10; B64C 27/32

(57) ABSTRACT

This Invention is a new article of manufacture that provides an Aircraft with a modular high-performance Lift Module System that both creates an alternative modular building method to simplify aircraft construction and modification through removable lift modules and also enables the aircraft to change flight direction or begin flying toward any direction immediately from a standstill or while under momentum without body roll and is controlled by computerized electronic controls such as fly-by-wire. Each lift point has two interconnected tilting points and has the ability to rotate rapidly up to 88 degrees with an optimal tilt angle of 45 degrees forwards or backwards and simultaneously 45 degrees in either lateral direction rapidly, which combined allow the lift module system to direct thrust in any given direction and change an aircraft's course allowing for rapid high-performance omni-lateral flight in any direction or toward any angle by redirecting thrust laterally or upwards or somewhere in-between, or by redirecting & reducing thrust for downward angled flight allowing an Aircraft body, specifically the Aircraft created by implementation of this invention called the Vertical Aerial Vehicle, to more rapidly maneuver and outperform all existing lift system while maintaining a more comfortable flight experience in that body roll, pitch and yaw can be controlled and even eliminated.

### TECHNICAL FIELD

This invention teaches a new article of manufacture to produce a high-performance lift system that enables an aircraft to fly more rapidly into a new direction and decreases the time it takes to fly in a new direction compared to previous arts and inadvertently creates a new classification of high-performance aircraft when applied to an aerodynamic body and eliminates the need for pitch or roll of the Aircraft body, utilizing continuous thrust of at least four evenly distributed lift points powered by at least one propeller each that can pivot up to 88 degrees forward or backward with a cruising optimal pitch of around 45 degrees & up to 88 degrees laterally in either direction with a cruising optimal pitch of about 45 degrees as well, tilting concurrently to achieve rapid re-directional flight of the aircraft toward any new direction 360 degrees, to give maximum control of the Aircrafts directional momentum allowing the aircraft to fly laterally or toward any direction and/or at any angle while maintaining the same body position enabling body roll to be eliminated and/or precisely controlled, by maneuvering the lift points mounted to the sides of the vehicle in the general vicinity of where wheels are mounted on cars near the four corners from between the bottom of the vehicles body to the top of the vehicles body from the front of the side access doors stretching out forward up to 50% of the lift module radius beyond the nose & from behind the side access doors stretching backward up to 50% of the lift module beyond the rear of the body of the craft to achieve constant vertical aeronautical flight without fixed horizontal wings as are used on Airplanes, modern eVTOL's or Jets.

### BACKGROUND OF THE INVENTION

Lift systems are the combination of mechanical and structural engineering to achieve lift & control of the body of an Aircraft for various purposes and there are 4 main types of Aircraft designs currently that each utilize a different lift system including: Airplanes & Jets, which are in the same category, Helicopters, VTOL Airplanes & VTOL Passenger Drones.

Lift is the mechanical and structural process that enables aircraft to fly.

Aircraft are structural vehicles that utilize lift systems to achieve controlled flight in the air.

Aviation is the act of flying or operating an aircraft and the Movement and direction of all Aircraft are determined by pitch, roll & yaw which are respectively how an aircraft moves along its X, Y & Z axis or, lateral, longitudinal and vertical axis, and each type of Aircraft requires a different set of mechanical moving parts to produce pitch, roll & yaw which also requires a different set of flight controls.

The Kite is the earliest and simplest version of an aircraft and is controlled by a string. Kites have undergone an evolution of their own and can now be controlled with two-handed operation, where pulling in either direction changes the flight path of the kite causing it to roll to the left or right and increased elevation is achieved by letting out more string or drawing the string in. Kites have also been introduced into watersports and wakeboarders use them in lieu of a powered watercraft to ride along the water and perform aerial maneuvers via two handed controls and a harness that they wear linking themselves to the kite.

The first aircraft flown by a person, the Airplane, was created by the Wright Brothers. Later came a new kind of aircraft, the Helicopter, introduced by Igor Sikorsky and afterwards, in the early 1920's, the first attempts were made at a quad copter, but it was abandoned due to its ineffectiveness as flight times were limited to 15 minutes and the aircraft could only carry one person and took up the same footprint as four modern day helicopters and used about as much fuel. The Jet was later introduced in the 1950's and flies on the same principals as airplanes, the only difference being the flight controls and the source for thrust i.e., jet engines instead of propellers. In 1960 the first modern VTOL aircraft was designed which stands for vertical takeoff and landing that converted to an airplane and was limited to approximately 15 mins of vertical flight or hovering and the concept was abandoned. In 2016 the first Passenger Drone was introduced with a fixed wing vertical lift systems by the company Ehang and today there is an American manufacturer, Workhorse, currently in the FAA Certification Process with a vertical fixed wing passenger drone that utilizes thrust manipulation to provide directional control and many manufacturers are introducing eVTOL Airplanes, which stands for electric vertical takeoff and landing and versions are being developed by major Aircraft Manufacturers and finally Passenger Drone eVTOL that convert to Airplanes that have an appearance of a Passenger Drone or quadcopter which utilize a ducted housing to act as the wings of an airplane.

Airplanes & Jets generate lift utilizing mechanical thrust and aerodynamic wings that have other moving parts that all combined achieve controlled flight.

Helicopters have a main rotor that acts as a horizontal wing and each blade to the main rotor rotate to control the pitch and direction of the aircraft and a tail rotor that spins perpendicular to control and stabilize the body of the craft and assists in controlling the direction when turning.

VTOL airplanes talk off & land vertically but fly mainly by utilizing forward horizontal lift just as airplanes and have limited weight restrictions for VTOL and limited durations for vertical flight and most offer the STOL alternative, which stands for short takeoff and landing, which requires a shorter landing strip for runway take offs.

Fixed Propeller Passenger Drones, or manned Quadcopters, use thrust applied to individual or grouped spinning rotors to achieve elevation changes, pitch, yaw and roll which result in the body of the aircraft rocking from front to back and rolling side to side to provide directional control and removes the need for the ailerons, rudder and elevators as found on airplanes. The programming that controls remote control drones is the basis for how manned Aircraft quad copters currently maneuver. Modern day aircraft of this type include the Ehang single passenger drone and the Horsefly 2 passenger drone, which do less rolling & tilting of the body verses the RC counterparts and are intended for low performance flight with minimal maneuvering. In fact, the Ehang 184 is designed to fly slow and gently without any body roll whereas the Horsefly may implement minimal body roll into its maneuvering.

eVTOL Passenger aircraft, which were introduced after fixed wing passenger drones, take off and land vertically but convert to forward horizontal flight and then fly the same as airplanes. Modern day aircraft of this type include the Porsche x Boeing & the Bell Nexus 6HX.

Pitch is what fixed-wing Aircraft use to point the nose of the Aircraft up or down to increase or decrease elevation or to increase turning radius while rolled to change heading. The longitudinal axis runs along the wingspan and aircraft pitch with respect to it. The more pitch on an Aircraft the more perpendicular it is to its current heading. Pilots achieve Pitch by pulling back or pushing forward on the yoke or wheel which in turn moves the two elevators located along the narrowing edge or rear of the tail wing. Pushing forward moves the elevators down which pushes the tail up and achieves pointing the nose of the airplane downward and pulling back pushes the elevators up which pushes the tail down and achieves pointing the nose upward. Pitch is mainly used to change the elevation of the aircraft or increase the turning radius.

Roll is what fixed-wing Aircraft use to spin or roll one wing tip downward useful in changing direction or heading in conjunction with pitch and/or yaw. Stunt or performance Aircraft will use roll to spin the Aircraft around a full revolution while maintaining elevation and heading. The lateral axis runs along the fuselage from nose to tail and the aircraft rolls with respect to it. Airplanes achieve roll when pilots apply rotation to the wheel or yoke.

Yaw enables an Aircraft to change heading without rolling or pitching the aircraft by moving the mechanical rudder at the tail of the aircraft. This is achieved by pressing the floor pedals. The vertical axis runs perpendicular to the fuselage between the two wings and the nose & tail of the aircraft change direction with respect to it. The left pedal will cause the aircraft to rotate and point in a different direction and slight adjustments are made to straighten the aircraft with respect to its appropriate heading.

The Wings of an Airplane are used to create lift and require the aircraft be travelling at a constant minimum speed in order to stay in the air and many other smaller moving parts work together to achieve control of the aircraft.

The elevators are located on the tail wing and control the pitch of the aircraft with respect to the lateral axis. Movement of the elevators will make the tail go up or down and respectively the nose will do the opposite and put their aircraft into a climb or dive from a neutral level flying position.

The ailerons are located on the back side or narrowing edge of the wings and control the rolling motion with respect to the longitudinal axis. Movement of the ailerons will cause the tips of the wings to point downward while the aircraft maintains a level altitude.

The rudder is located on top of the tail wing and moves in the same way as the rudder on a ship and controls which direction the aircraft points with respect to the vertical axis. Movement of the rudder will cause the aircraft to veer off into a new direction while the aircraft maintains a level altitude.

The throttle is hand controlled and is used to increase or reduce airspeed by pushing it forward and backward respectively.

The yoke is positioned as a steering wheel in front of the pilot in most planes and as stick in open cockpit style airplanes like the infamous Red Barron and controls the pitch and roll of the aircraft by pulling or pushing the wheel or stick to pitch the aircraft and by rotating, or turning, to roll the aircraft; in the case of a stick control it is moved from left to right to create the rolling effect.

The pedals are foot controlled and move the rudder left or right to change the yaw or in other words, the direction the aircraft is pointing.

Helicopters have three controls that determine elevation, pitch, roll & yaw and they maneuver two propellers. The collective is a hand pulled control that moves like a center console emergency brake as found on some vehicles and is used to determines the pitch angle of the blade and the greater the pitch angle the more lift the helicopter creates so, as the rotors tilt downward the helicopter goes up. The Cyclic is a stick positioned between the pilots' legs that makes the helicopter go forwards, backwards, left and right by pushing it in the respective direction and essentially the cyclic stick leans the rotors toward the desired direction. When the cyclic is applied forward the ends of the blades will be down towards the front and up towards the back creating the pitch angle that flies the aircraft forward. Finally, the pedals control the tail rotor which is used to counterbalance the rotation of the top propellers and to yaw the aircraft when turning. The centrifugal force of the top propellers spinning would spin the entire aircraft around and by applying pressure to either pedal the tail rotor increases or decreases its pitch angle until the desired outcome is met.

Early remote-control drones, and still most consumer remote control drones today, utilize the forward tilting of the body like helicopters to gain acceleration, however modified versions are available that offer forward and reverse tilt of the propellers to accelerate and decelerate the aircraft while keeping the body stable and in movies futuristic aircraft are depicted flying by utilizing forward and reverse vectoring of the four lift points and to turn they increase the forward tilt of one side.

Fly-by-wire is a semi-automatic computer-regulated system for controlling the flight of an aircraft or spaceship and are responsible for moving the mechanical parts that determine pitch, roll and yaw based on its pre-programmed fixed responses that correspond to the movement of the input flight controls and are instrumental in moving the mechanical aspects any lift system.

Ground vehicles use wheel hub assemblies to mount the wheels onto a vehicle and the four hub assemblies support the weight of the entire vehicle on a set of four wheels that have tires mounted that hold air.

The main drawback of existing aircraft is their need for the body of the aircraft to roll from side to side to change direction and or tilt from front to back in order to change elevation or slow down, giving them a limited ability to safely fly the aircraft into a new direction.

Another drawback with existing lift systems is with regard to obstacle avoidance in that existing aircraft must increase their vertical landscape in order to move out of the way of an incoming object. By increasing their vertical landscape, they are creating an increased airspace hazard which will become one of the most significant concerns in the future as society increasingly adopts aerial transportation as a common mode of transportation.

Yet another drawback to airplanes and helicopters is their high number of moving parts that require both expensive & extensive training as well as high maintenance and hundreds of hours of flight time to master.

What this invention does is allow for rapid directional changes, redirecting the aircraft toward any direction or angle forwards, backwards, left or right, up or down, or anywhere in between from any direction, toward any direction.

This invention introduces a new concept of Lift Modules, which are independent parts that mount to the body of an aircraft and contain lift creating components that offer control of an airframe and is intended to work in concert with four or more total lift points evenly distributed at the sides of an aircraft.

This invention is intended for a specific new classification of Aircraft that fly on an individual or grouped rotor tilt control principal combined with individual or grouped rotor thrust manipulation and are Vertically Engineered Rapid-Re-Directional-Rotor Tilt Innovatively Controlled Angular Lift Aircraft, which is defined by the Lift Systems positioning being mounted at or near where wheels are mounted on ground vehicles, being a minimum of four lift points, as well as by the implementation of this invention and specialized controls that only have full implementation with this aircraft.

In yet another aspect of this invention it introduces a new modular approach to building and aircraft and promoting individualized flight in that an aircraft utilizing this invention can be upgraded with larger, more powerful lift modules and even different types of lift modules that create lift in various ways like jet propulsion lift modules, hidden propeller or “bladeless” designs, or new technologies that may arise and this introduced the vehicle modification element for higher performance as seen in ground production vehicle performance modifications.

This invention presents a highly maneuverable and highly precise balanced four-point lift systems that allows for greater air mobility than any existing or historical lift system in that the body of the craft can remain stable front to back, level side to side and unaltered while the aircraft flies in any direction and at any angle without the body having to experiencing roll, pitch or yaw, allowing for a more controlled, comfortable and stable flying experience. Due to the increased maneuverability, this invention allows an airframe to achieve safer flight compared to any other lift system currently in production and does allow for omni-directional braking in that this system can fly the aircraft toward any direction rapidly and stop the aircraft without changing direction, from any direction, all while the body of the aircraft maintains facing a fixed direction.

### SUMMARY OF THE INVENTION

Accordingly, there is a need in the field for this invention.

This present invention is a new method of manufacture that utilizes Dynamic Tilt that results in Re-Directional Lift controlled by four spinning wing lift modules that create a Lift Module system that stabilize an aerodynamic body which enables that aircraft to fly rapidly from a mid-air standstill, or from any heading of momentum, to immediately change course and fly in any new direction or at any angle laterally, upward, downward or in reverse, toward any direction and at any angle around the craft as well as come to a complete rapid midair stop from any direction, all of which are accomplished by utilizing a four point two-way concurrent tilt lift system and a dynamic computer programmed flight system that controls the amount of tilt based primarily on airspeed and/or amount of acceleration to achieve elevation and directional changes for Vertical Aerial Vehicles which fly primarily on a new lateral 360 degree tilt principle, or an omni-lateral tilt principal that results in omni-lateral flight, but still implement individual lift point thrust manipulation to achieve different desired flight responses as it builds on and improves the existing flight platform of modern 4-point lift Passenger Drones and remote control drones.

The lift points in the invention consist of four downward thrusting and two-way simultaneous tilt capable spinning wings, which are located at the sides of the body that provide balanced lift. The lift point consists of a ducted housing around the propeller that supports the propeller and the electric motor & is itself held in place by a hollowed C shaped arm called the Tilt Wing Arm, which is a key part of this inventions design, that rotates forwards and backwards up to, but does not necessarily need to be limited to, 88° with an optimal tilt angle of 45°, where the middle of the tilt wing arm is connected to a high speed tilt electromagnetic actuator that is mounted directly to the airframe of the aircraft via an airframe adapter. The main tilt actuators are mounted in the general area of where wheels are located on ground vehicles. The tilt wing arm extends perpendicular to the main tilt actuator and holds the ducted propeller housing that is itself tilted by two smaller secondary tilt actuators located at the ends of the arms of the Tilt Wing Arm, that provide a 176° of lateral tilt (88° in either direction) with an optimal tilt angle of 45 degrees in either direction, which combined with the forward/backward tilt actuators allow the aircraft to achieve flight in any direction with or without body roll, body pitch or body yaw as this invention provides the roll & pitch allowing the aircraft body to maintain a constant level and straight position if desired, but also allowing the body to face a new direction or any direction through dynamic tilt manipulation combined with increasing thrust to groups of wings allowing for a greater level of control.

Each lift point is a Lift Module, which is an independent part that mounts to the body of an aircraft and contains lift creating components that offer control of an airframe and is intended to work in concert with four or more total lift points evenly distributed at the sides of an aircraft.

The Airframe adapter is married to the airframe and is shown as an independent piece for demonstrative purposes. The intended airframe that would utilize this invention will have a minimum of four lift points but two and three would accomplish lift successfully, however, the purpose of this invention is to provide high-performance flight which is best achieved with four or more. Going up from four the next increment would be six then eight then ten and can be increased by a minimum of two with no maximum to support larger airframes where maximum size is determined by utilization and supporting infrastructure. The size of each individual lift module can be as large as the airframe can support with the optimal size being in proportion to the size of the intended airframe's width, not to exceed 1.25 times it's width. The size of each individual lift module can be as small as manufacturing allows and could be utilized on small remote-control aircraft. The total area of lift needs to be proportionate to the total area of the body and shouldn't extend to far beyond the nose of the craft or tail of the craft and respectively it will not extend too wide. A good rule of thumb for vertical aircraft utilizing this invention is that the two-dimensional top-down area of lift should be equal to or greater than the total two-dimensional top-down area of the body of the airframe per upward of 6 feet of three-dimensional depth, optimally 3-4 feet, of the body of the airframe. For airframes greater than 6 feet of height from top to bottom, the two-dimensional top-down area of lift requirements will increase requiring stacked lift points that increase the lift capacity up to double the total lift for that given vertical landscape through 45 degree offset equalizing directional downward thrust which is then manipulated for directional control wherein the two stacked lift points are spaced far enough apart that their respective radius's do not conflict when tilting for directional thrust.

Additionally the lift points are mountable, removable and upgradable offering a modular approach to building an Aircraft allowing the owner to upgrade or swap out the individual lift modules with different sizes or to achieve various types of lift like sport, torque or speed or to increase power or to implement different types of lift modules that create lift in various ways like jet propulsion lift modules, hidden propeller or “bladeless” designs, or new technologies that may arise which introduces the ability to implement style & performance enhancements as commonly seen with vehicle modifications in ground production vehicles, creating a potential modification market place for this new classification of Vertically Engineered Rapid-Re-Directional-Rotor Tilt Innovatively Controlled Angular Lift Aerial Vehicle.

As Ground vehicles use wheel hub assemblies to mount the wheels to the vehicle frame, Vertically Engineered Rapid-Re-Directional-Rotor Tilt Innovatively Controlled Angular Lift Aerial Vehicle's, or Vertical Aerial Vehicles for short that are the type of aircraft created by this invention, use lift hub assemblies that have extra-large tapered roller bearings to support all the weight of the aircraft and the torque created by the high-performance lift points. The lift system consists of four lift modules that are each supported by a lift hub assembly. Each lift hub assembly is tilted by an electromagnetic actuator called the main actuator. The C-shaped arm, which is mounted directly do the lift hub assembly, supports two smaller lift hub assemblies mounted near the end of each arm extension that provides lateral tilt rotation of the ducted housing that supports the electric motor and propeller and are tilted by two smaller electromagnetic actuators called the secondary actuators that work together to provide an equal amount of tilting power as the main actuator.

The accelerator plays a definitive roll in altitude and directional changes in that the lift system will have a maximum tilt based on the acceleration level which means that greater directional changes are accomplished with greater acceleration. This invention provides a new way to change the direction of the Aircraft in that it has a sideline flight capability which is achieved by engaging the appropriate flight controls. Sideline flight is defined as flying the aircraft laterally while the body of the aircraft maintains its forward-facing body position while the aircraft flies laterally from either a hover or during forward flight. The flight control can be tapped once, double tapped, or held down to engage right or left lateral flight while in a hover or while moving forward or while flying in reverse or even while flying straight up or down. A single tap to either of the sideline flight controls will result in the equivalent of a single lane change like changing lanes on a highway and a double tap is the equivalent of a two-lane changes & holding the sideline flight control in either direction will cause continuous lateral flight until the control is released at which time the aircraft will resume flight based on the input controls. The sideline controls can help to manipulate the aircraft into specific angles when being used in combination with the yoke or steering wheel which increases the angles the aircraft can fly toward.

The Aircraft is controlled by utilizing a flight control system such as fly-by-wire or similar and consists of a series of control boxes and electronic components including one Flight Control Computer, one Gear Control Box, one Yoke & Pedals Control Box, four Main Actuator, Secondary Actuator's & Electric Motor Controls Boxes, four Main Actuators, four sets of two secondary actuators & four electric motors. The flight control computer sends preprogrammed commands to the four main actuator, secondary actuators and electric motor control boxes based on the inputs to the gear control box and the yoke and pedals control boxes. Those commands determine the speed of rotation of the electric motors and the degree and direction of tilt to each individual main actuator and to each set of secondary actuators which inadvertently determines how the aircraft flies through the sky. The electronic wiring is tunneled through hollowed sections of the body and lift modules.

This invention flies the body of the craft in any direction from a hovering standstill or while in motion, it can rapidly redirect its thrust and begin flying in any new direction including sideline or sideways flight without body roll being required.

This invention provides a first time in history instantaneous rapid lateral redirection or a lateral directional change capability of an aerial object and therefore is fitting as a descriptor to refer back to what this invention does in reference to the facing of the propeller's thrust in that the propeller can be faced in any direction and the aircraft itself undergoes that directional change based on the direction of the thrust of the propeller and the thrust of the propellers of this invention are re-directional in a synchronized manner and in an unsynchronized manner.

This invention provides an aircraft with the highest maneuverability possible and outperforms any existing aircrafts maneuverability and is designed to create High Performance Aircraft and the increased maneuverability is valuable with respect to obstacle avoidance and overall flight safety making this solution also the best solution for all forms of aerial vehicles including those intended for public transportation as the propellers are not exposed and the aircraft can come into gentle contact with other objects during flight & at low speeds if flying in the same direction and can be rated and designed for being able to withstand light impact to heavy impact.

Each individual lift point of this invention is optimally sized to be a ratio of 0.75 to 1.5 times in diameter the size of the airframe's width with the exception of longer airframe's that exceed 5 times the width in length wherein the lift module size could be increased slightly provide greater lift capacity or additional side mounted lift points could be added.

In one aspect this invention provides a consistent level smooth flight experience in that elevation changes, turns and stopping can be achieved without pitch or roll of the body as this invention provides up to 100% of the Body roll, pitch and yay and this invention can be modified to accentuate or eliminate body roll, pitch & yaw to the pilots, owners or manufacturers own liking.

In another aspect this invention offers a turning radius while in flight, which is better described as the ability to spin the aircraft around which no other aircraft can achieve and can dynamically start flying in any direction including downward, upward, laterally or at any angle or in reverse.

In yet another aspect this invention allows the aircraft to fly toward downward angles by reducing the directional thrust or tilting the propellers further under the same thrust so that the aircraft flies downward instead of directly lateral or upward.

In yet another aspect of this invention the tilt wing arm, which is C-shaped in the examples, can also be a half C-shaped arm that only extends to connect to the back side and would support the entire ducted prop housing from one lift hub assembly at the end of the one half of the C-shaped arm. It could also be an O-shaped arm that fully encircles. Rapid forward rotation combined simultaneously with rapid lateral rotation, regardless of how this is achieved, is what this invention offers and how this invention improves control of an airframe during flight.

In another aspect of this invention, lift modules can be designed to be smaller to work together with other identically sized lift modules that form a group creating one larger lift module that is made up of multiple smaller lift modules that work together in a synchronized or unsynchronized manner to create lift or thrust and or multidirectional thrust and can be placed in line with each other or in two or more rows to achieve the desired performance and lift. One advantage of this would be to minimize the overall motion of a lift point so that instead of three feet of travel the smaller grouped points would only have one and a half feet of travel to achieve the same directional change.

The performance enhancement aspect is in and of itself something that is common in ground vehicles and would rarely be done in existing aircraft designs but is part of what makes this invention unique in that it can easily be modified, thus creating a new type of aircraft. The lift modules of this invention can be removed almost as simply as changing wheels on a ground vehicle. Each individual lift point is optimally limited in size to be a ratio of 1.5 times or less the size of the airframe's width and a ratio of 0.6 or less the size of the airframe's length, where in an airframe with a width of 6 feet and length of 16 feet would optimally support a lift module with a radius of up to 9 feet.

Forward and reverse tilt is currently available to consumers on toy aircraft, however, this improvement of rapid two-way tilt, to allow for rapid lateral instantaneous flight into any new direction, is unique and offers tremendous advantages to outperform any prior lift system designs, especially with respect to the rapid response capabilities allowing the aircraft to dodge incoming objects rapidly.

With these and other objects in view that will more readily appear as the nature of the invention is better understood, the invention consists in the novel process and development, combination and arrangement of structural engineering, mechanical engineering and hereinafter more fully illustrated, described and claimed, with reference being made to the accompanying drawings in which:

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 Pictured is a single lift point of this invention called a lift module.

FIG. 2 Pictured is a top-down view of an airframe utilizing the four lift points of this invention.

FIG. 3 Pictured is an angled view of an airframe utilizing the four lift points of this invention.

FIG. 4 Pictured is an upward view of an airframe utilizing the four lift points of this invention.

FIG. 5 Pictured is an angled exploded view of this invention.

FIG. 6 Pictured is an angled view of an isolated ducted propeller housing.

FIG. 7 Pictured is an angled view of the C-shaped Tilt Wing Arm.

FIG. 8 Pictured is a transparent image of an end of the tilt wing arm, an electric secondary tilt actuator, a lift hub assembly and a set of four bolts & 12 lug nuts.

FIG. 9 Pictured is a transparent close-up view of the tilt wing arm, the main lift hub assembly and a set of lug nuts.

FIG. 10 Pictured is an exploded transparent view of the main lift hub assembly.

FIG. 11 Pictured is a close-up, side view of an exploded main lift hub assembly.

FIG. 12 Pictured is a side view of the main lift hub assembly together.

FIG. 13 Pictured is a side view of a Vertical Aerial Vehicle that is utilizing this invention to achieve forward flight.

FIG. 14 Pictured is an angled view of a Vertical Aerial Vehicle that is utilizing this invention to achieve forward flight.

FIG. 15 Pictured is a side view of a Vertical Aerial Vehicle that is utilizing this invention to stop or fly in reverse.

FIG. 16 Pictured is a front view of a Vertical Aerial Vehicle that is utilizing this invention to stop or fly in reverse.

FIG. 17 Pictured is a rear angled view of a Vertical Aerial Vehicle that is utilizing this invention to achieve low speed lateral or sideline flight to the right.

FIG. 18 Pictured is a front angled view of a Vertical Aerial Vehicle that is utilizing this invention to achieve low speed lateral or sideline flight to the left.

FIG. 19 Pictured is a rear view of a Vertical Aerial Vehicle that is utilizing this invention to achieve high speed lateral or sideline flight to the right.

FIG. 20 Pictured is a front angled view of a Vertical Aerial Vehicle that is utilizing this invention to achieve high speed lateral or sideline flight to the left.

FIG. 21 Pictured is a rear view of a Vertical Aerial Vehicle that is utilizing this invention to achieve high speed forward and lateral or sideline flight to the left.

FIG. 22 Pictured is front side angled view of a Vertical Aerial Vehicle that is utilizing this invention to achieve high speed forward and lateral or sideline flight to the right to achieve angled flight while maintaining a level forward facing body.

FIG. 23 Pictured is a rear side angled view of a Vertical Aerial Vehicle that is utilizing this invention to achieve low speed forward flight.

FIG. 24 Pictured is a front view of a Vertical Aerial Vehicle that is utilizing this invention to achieve low speed tilt rotation from a hover.

FIG. 25 Pictured is an angled view of a Vertical Aerial Vehicle that shows the four lift hub assemblies without the lift modules shown

FIG. 26 Pictured is a diagram of the fly-by-wire system used by this invention.

### DETAILED DESCRIPTION AND BEST MODE OF IMPLEMENTATION

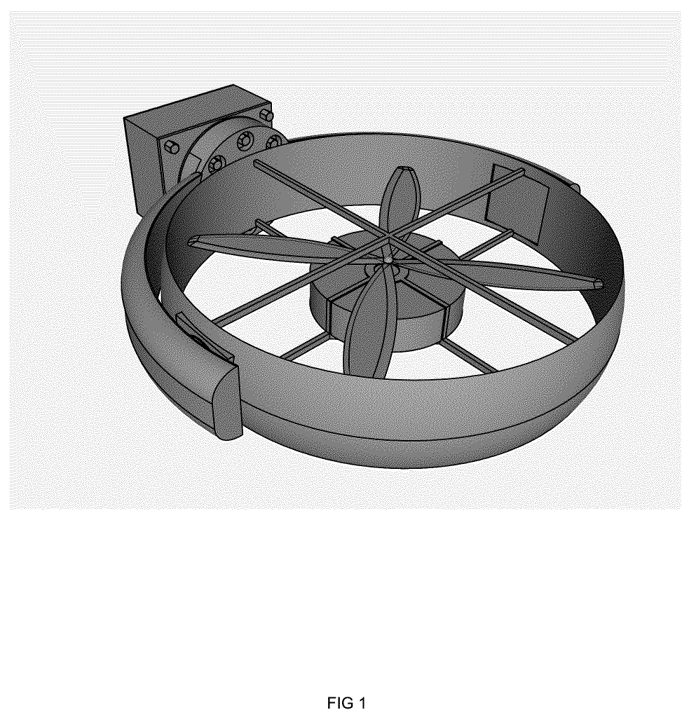

FIG. 1 This Drawing is an angled view of a single lift point of this invention that is called a lift module. A minimum of four of these are used on an Aircraft to enable a new method of controlled flight through advanced wing manipulation. The object in this picture is called the Rapid Re-directional Two-Way Concurrent Tilt Lift Module and is depicted mounted to the airframe adapter, which is part of the airframe but shown isolated here for demonstrative purposes and is an integral part of the lift module system. It is capable of rapidly tilting a propeller to face any direction 360 degrees up to 88 degrees of tilt by tilting in up to two directions simultaneously.

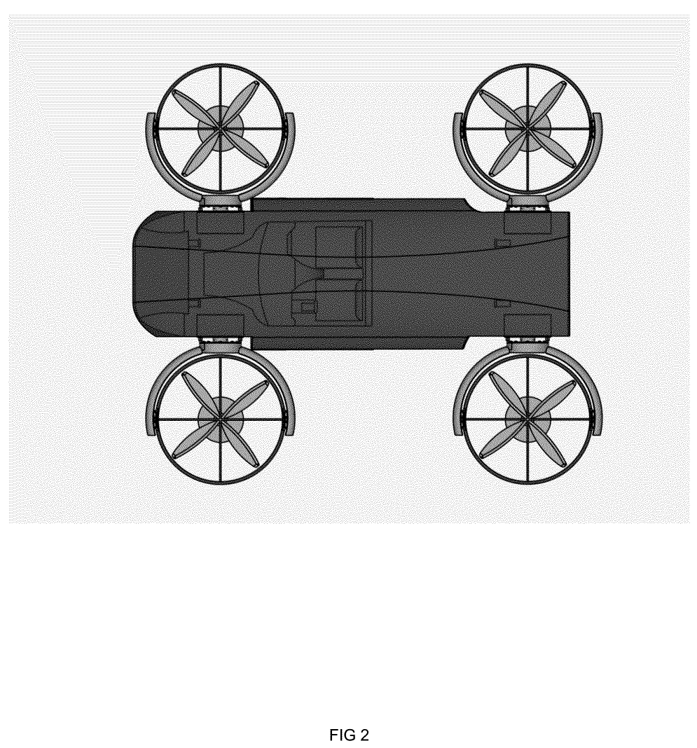

FIG. 2 This drawing is a top-down view of an Aircraft that is a new classification of Aircraft in that it utilizes this invention's new wing manipulations to achieve flight. The four lift modules of the system are in their neutral position and the aircraft can hover in a fixed position, increase or decrease elevation or gradually come to a stop from forward, lateral or reverse flight in this position.

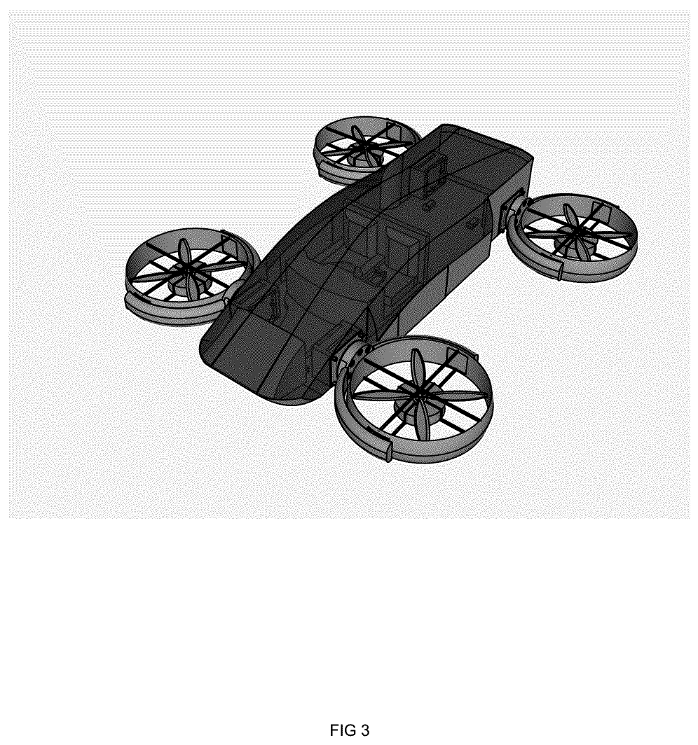

FIG. 3 This drawing is an angled view of a Vertical Aerial Vehicle that utilizes this invention to achieve flight. The four lift modules of the system are in their neutral position. The purpose of this illustration is to provide another viewpoint to give a better picture of how this invention appears.

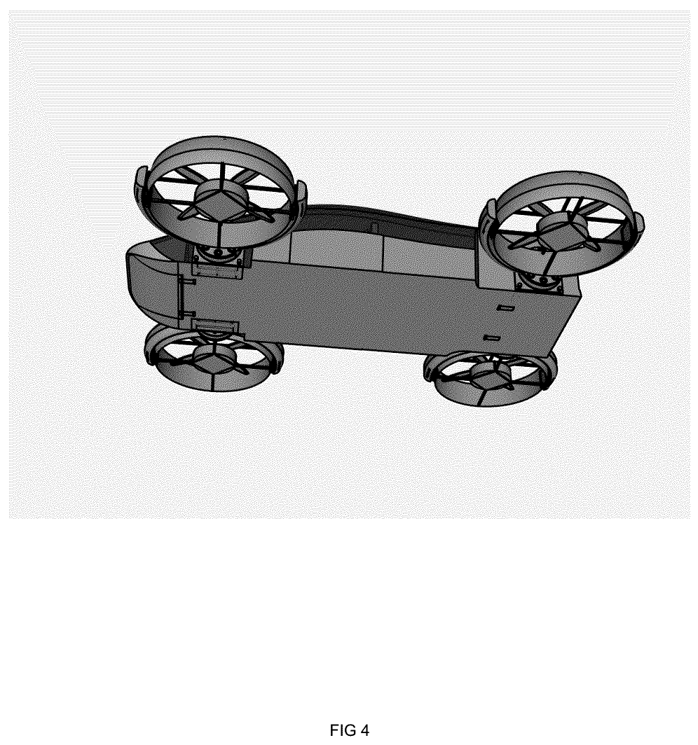

FIG. 4 This drawing is an upward angled view of a Vertical Aerial Vehicle utilizing this invention to achieve flight. The Aircraft if hovering in this image. The purpose of this illustration is to provide yet another viewpoint to give a better picture of how this invention appears as it is hovering in the sky.

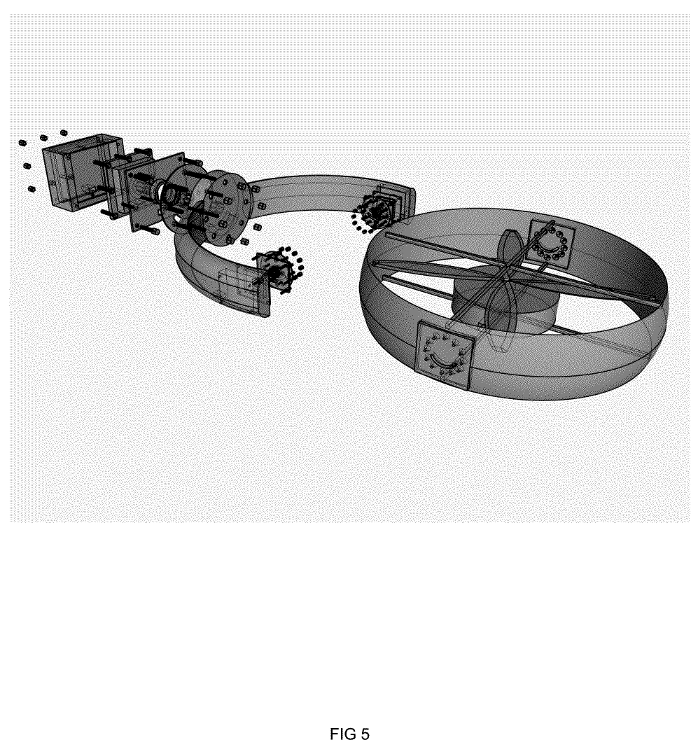

FIG. 5 This drawing is an angled exploded view of a single lift point of this invention. From right to left, this invention consists of a ducted prop housing that support the Axial Flux or other Electric motor and the propeller or wing, then the tilt-wing arm that house's two actuators and two lift hub assemblies responsible for tilting the ducted prop housing at either end of the tilt wing arm with their respective bolts and lug nuts, then the exploded main lift hub assembly is to the left of the tilt wing arm with its respective bolts & lug nuts, then the main electromagnetic Actuator that drives the tilt of the tilt wing arm with its respective bolts & lug nuts, then the cube shaped airframe adapter that is actually a part of the airframe and finally eight lug nuts for mounting the main actuator.

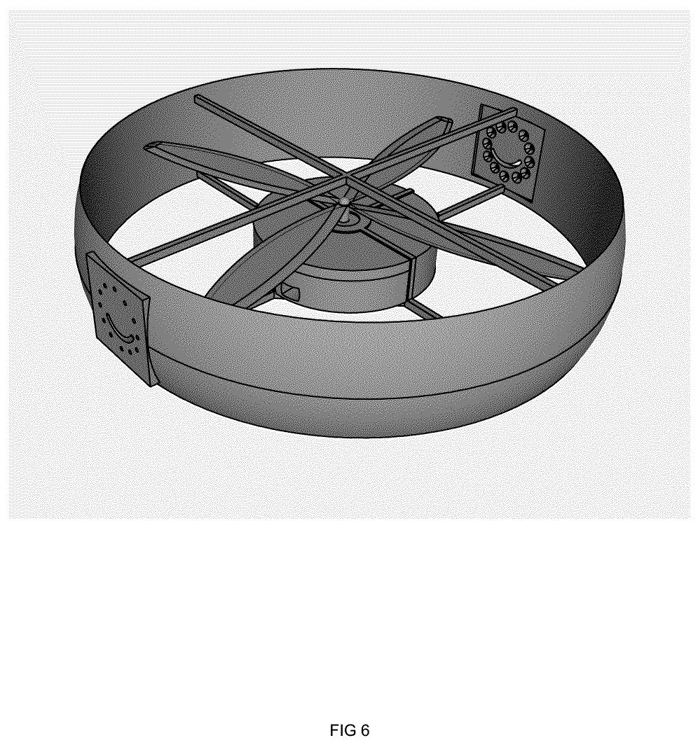

FIG. 6 This drawing is an angled view of the ducted propeller housing. Each side of the ducted prop housing has bolt holes to enable mounting to the two lift hub assemblies so that the secondary tilt actuator's on either side can engage. In the middle is a curved opening that allows the ducted housing to tilt up to 45 degrees but could be increased to tilt up to 88 degrees and this acts as the wire harness passage to allow for power to the Axial Flux or other electric motor which has a passage at the bottom for the wire harness to power the motor that is mounted to the bottom cross member of the ducted housing. The top cross member provides extra structural support for the housing. The curved passage allows for 45 degrees in either direction in this example but could be increased to allow for greater tilt.

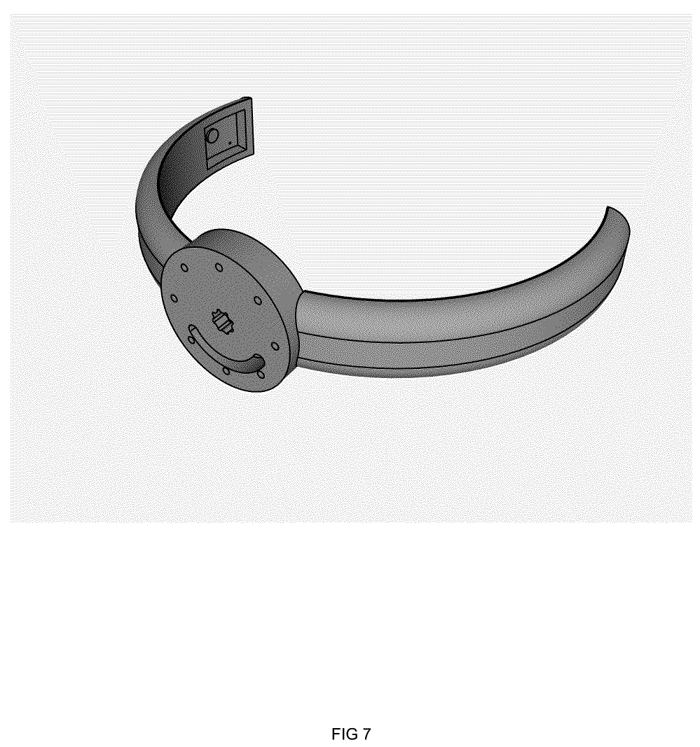

FIG. 7 Pictured is the C-shaped Tilt Wing Arm. At the end of each arm is square shaped recessed area where the secondary tilt actuators and secondary lift hub assemblies are bolt mounted. The center circular section has eight thorough through bolt holes that allow the tilt wing arm to be mounted to the main lift hub assembly. The star shaped notched opening in the center is to allow the shaft of the main tilt actuator to rotate the tilt wing arm. Below the notched hole is the 90-degree curved passage for the tilt wing arm wire harness to pass through and the passage continues through the hollowed arms to the square opening at the ends of each arm. The curved passage allows for 45 degrees in either direction, which is the optimal angle, in this example but could be increased to allow for greater tilt or greater optimization.

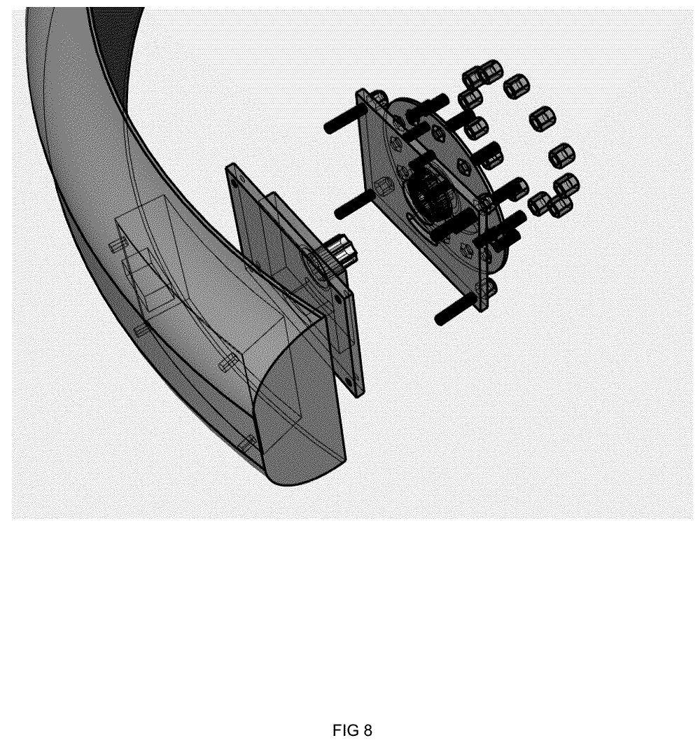

FIG. 8 Pictured is a slightly transparent image of the end of the tilt wing arm, the tilt actuator, the lift hub assembly and the bolts & lug nuts that mount the parts together including, not pictured, the ducted propeller housing to the tilt wing arm. The four bolts of the lift hub assembly pass through the four bolt holes of the actuator mounting both securely to the tilt wing arm. This is repeated on the opposite side of the arm. The bolts on the smaller lift hub assembly's, as depicted in this image, are not permanently affixed to the rotating plate to allow for easier assembly of the ducted housing.

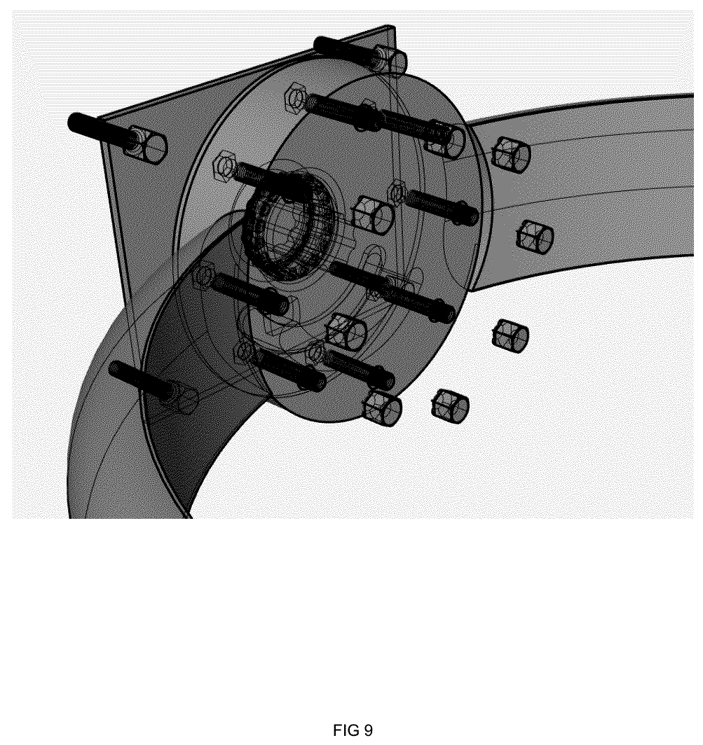

FIG. 9 Transparently pictured are a series of eight lug nuts that mount the tilt wing arm securely to the main lift hub assembly. To the right of the tilt wing arm next to the center rounded mounting section are a series of eight lug nuts, like those used to mount wheels on ground vehicles. These eight lug nuts mount the tilt wing arm to a lift hub assembly, like wheel hub assemblies used on ground vehicles.

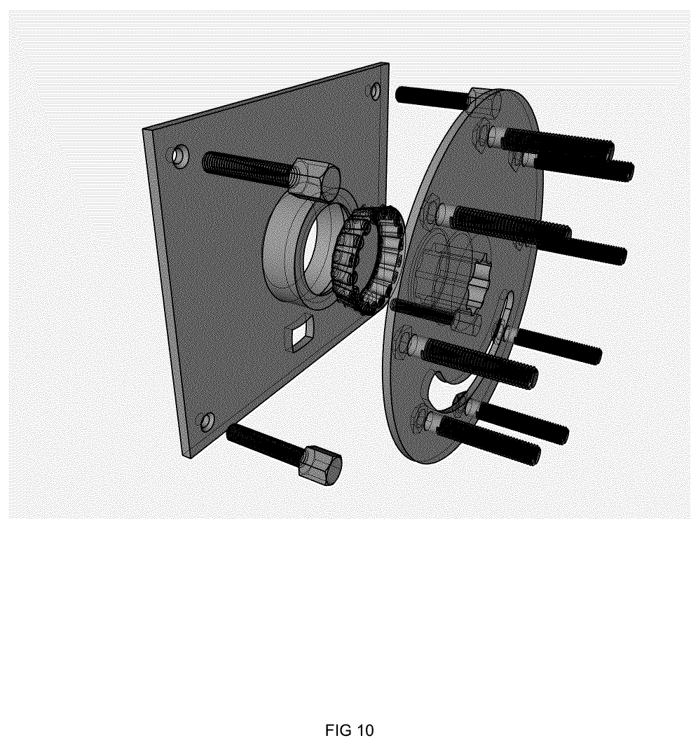

FIG. 10 Pictured is an exploded transparent view of the main lift hub assembly, which is identical to the two smaller secondary lift hub assemblies at the ends of the tilt wing arm. From left to right the lift hub assembly consists of the stationary mounting plate, the four main bolts, the tapered bearing & the rotating mounting plate. The rotating mounting plate has eight bolts that are permanently fixed upon which the tilt wing arm is mounted and the Stationary Plate, which is facing away from the tilt wing arm, has four bolts that mount the lift hub assembly to the aircraft via an airframe adapter. On the lower part of the stationary plate is passage for the wire harness & on the lower portion of the rotating plate is a 90-degree curved passage for the wire harness to allow the wire harness to remain stationary while the arm is tilting. At the center of the rotating plate is a notched shape that enables the main tilt actuator to tilt the rotating plate and, respectively, the tilt wing arm.

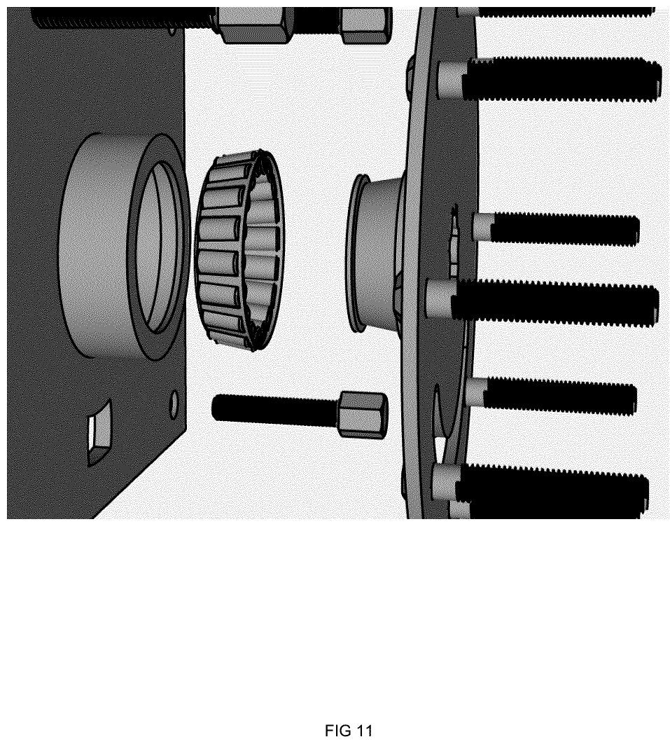

FIG. 11 Pictured is a closeup of the lift hub assembly to better show where the tapered bearing mounts around the protruding portion of the rotating mounting plate.

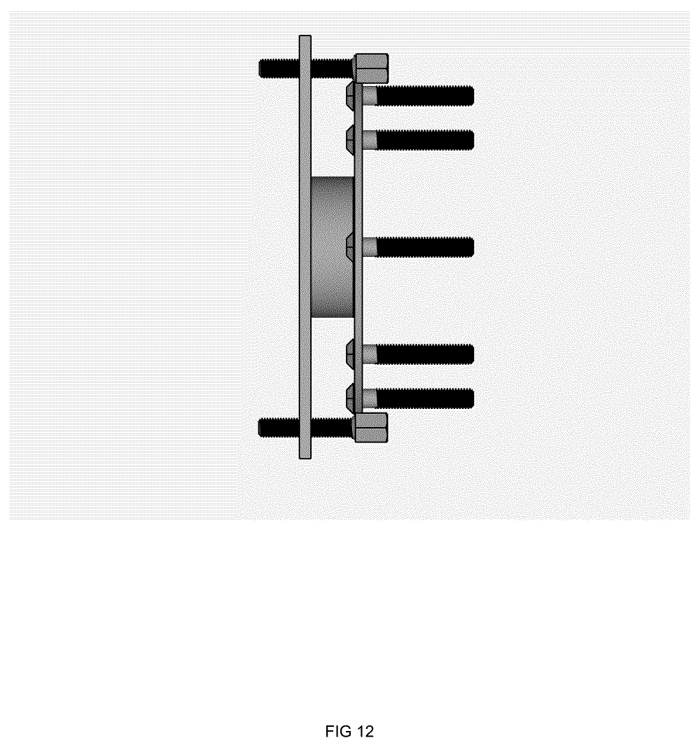

FIG. 12 Pictured is a side view of the main lift hub assembly assembled. The right side is the rotating plate that rotates as guided by the main tilt actuator.

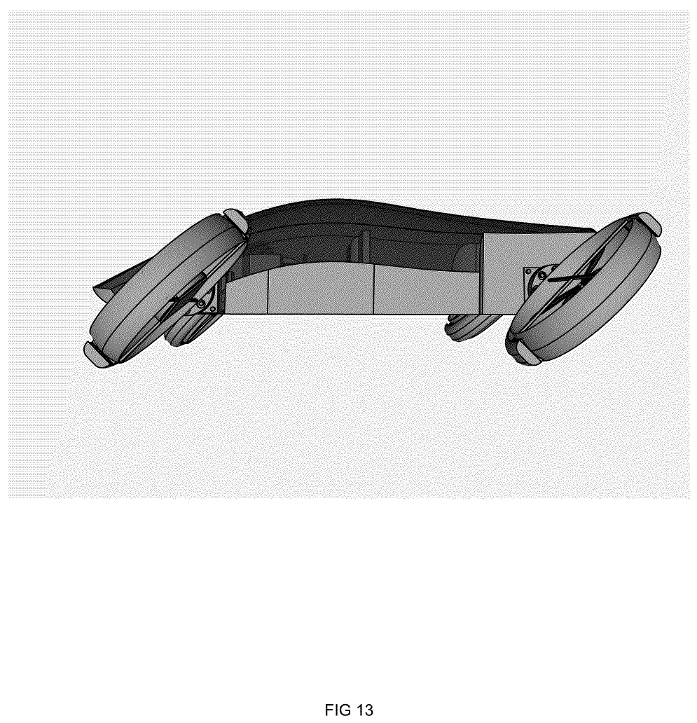

FIG. 13 This drawing is a side view of a Vertical Aerial Vehicle that is utilizing this invention to achieve flight. The four lift modules of the system are postured to fly the aircraft forward at a high rate of speed. The greater forward pitch is determined by the pilot's use of the acceleration input controls and the current pitch of the lift modules resemble full acceleration. This control is executed by the onboard flight control computer which takes speed, acceleration and obstacle avoidance information into consideration.

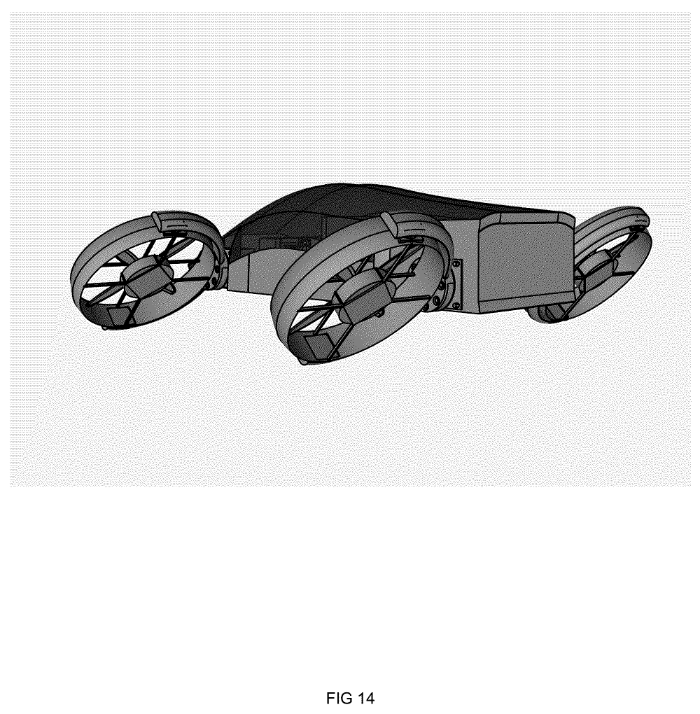

FIG. 14 This drawing is an angled view of a Vertical Aerial Vehicle that is utilizing this invention to achieve flight that offers another viewpoint of the maximum forward flight lift module position. The four lift modules of the system are postured to fly the aircraft forward at a high rate of speed. The greater forward pitch is determined by the pilot's use of the acceleration input controls and the current pitch of the lift modules resemble full acceleration. This control is executed by the onboard flight control computer which takes speed, acceleration and obstacle avoidance information into consideration.

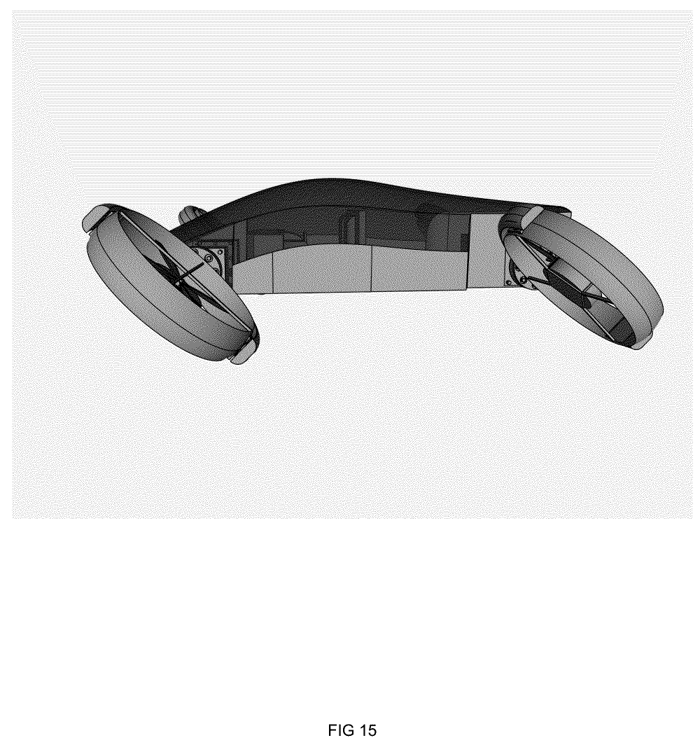

FIG. 15 This drawing is a side view of a Vertical Aerial Vehicle that is utilizing this invention to achieve flight. The four lift modules of the system are postured to stop the aircraft from traveling forward from a high rate of speed or to fly the aircraft in reverse.

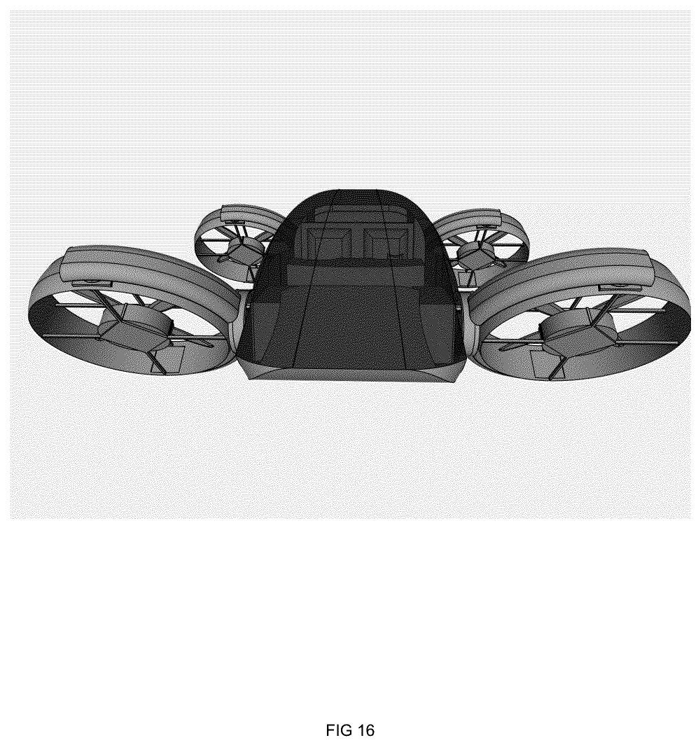

FIG. 16 This drawing is a front view of a Vertical Aerial Vehicle that is utilizing this invention to achieve flight. The four lift modules of the system are postured to slow down or stop the aircraft from traveling forward from a high rate of speed or to fly the aircraft in reverse. The purpose of this illustration is to provide another angle of the system so that it can be better understood.

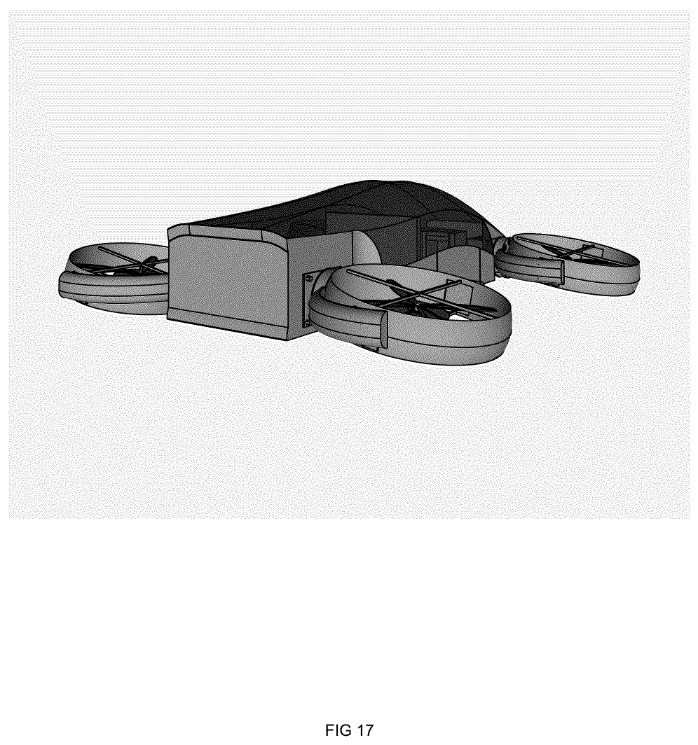

FIG. 17 This drawing is a rear angled view of a Vertical Aerial Vehicle that is utilizing this invention to achieve flight. The four lift modules of the system are postured to fly the aircraft laterally to the right. The slight side angled pitch of the ducted propeller housing is determined by the pilot's use of input controls the perform a maneuver called sideline flight which is means the aircraft will fly laterally while the body of the aircraft maintains its forward heading. The aircrafts starting displacement in this drawing was a hover and the accelerator has not been engaged and the computer system automatically accelerates the propellers slightly to move the aircraft laterally without applying roll, pitch or yaw to the body of the aircraft and maintaining the aircrafts elevation. This maneuver is executed by an onboard input flight control & computer flight control system which takes speed, acceleration and obstacle avoidance information into consideration.

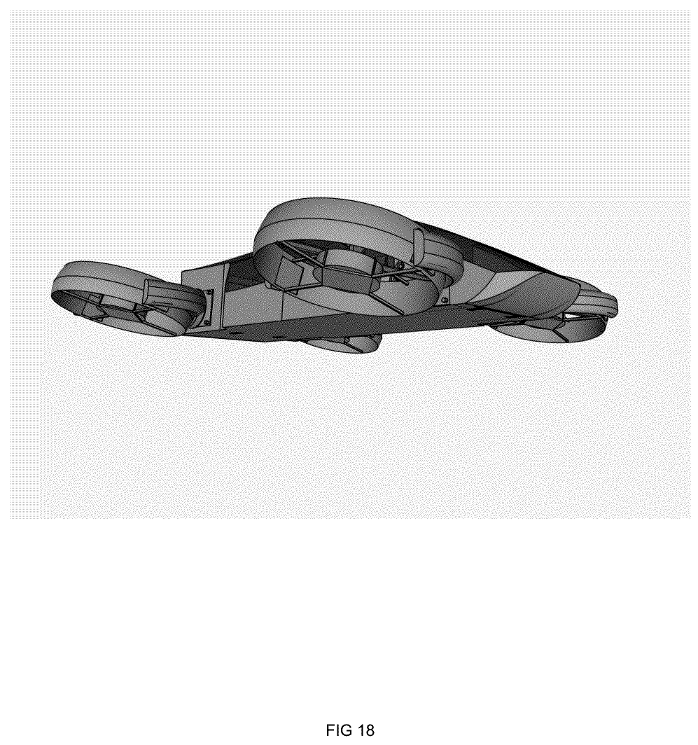

FIG. 18 This drawing is a upward angled view of a Vertical Aerial Vehicle that is utilizing this invention to achieve flight. The four lift modules of the system are postured to fly the aircraft laterally to the left. The slight side angled pitch of the ducted propeller housing is determined by the pilot's use of input controls to perform a maneuver called sideline flight. The aircrafts starting displacement was a hover and the accelerator has not been pressed & the computer system automatically accelerates the propellers slightly to move the aircraft laterally without applying roll, pitch or yaw to the body of the aircraft and maintaining the aircrafts elevation. This maneuver is executed by an onboard input flight control & computer flight control system which takes speed, acceleration and obstacle avoidance information into consideration.

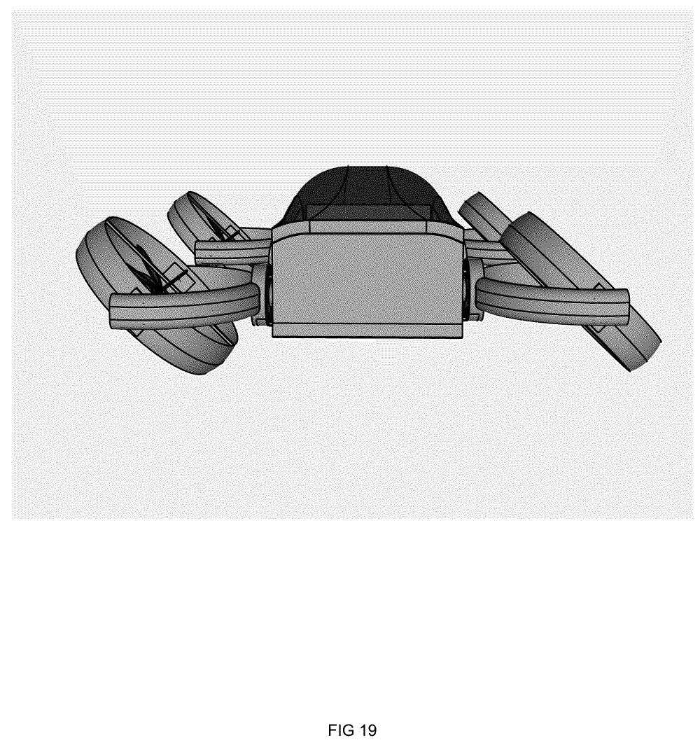

FIG. 19 This drawing is a rear view of a Vertical Aerial Vehicle that is utilizing this invention to achieve flight. The four lift modules of the system are postured to fly the aircraft rapidly to the right to perform a lateral sideline maneuver, thus providing roll the necessary roll for the airframe so that the airframe can remain level. The 45-degree side angle of the ducted propeller housings are determined by the pilots use of the input controls. Maximum acceleration has been applied along with the sideline flight control without forward input & the aircraft is flying laterally without applying roll, pitch or yaw to the body of the aircraft while the aircraft maintains elevation. This maneuver is executed by an onboard input flight control & computer flight control system which takes speed, acceleration and obstacle avoidance information into consideration.

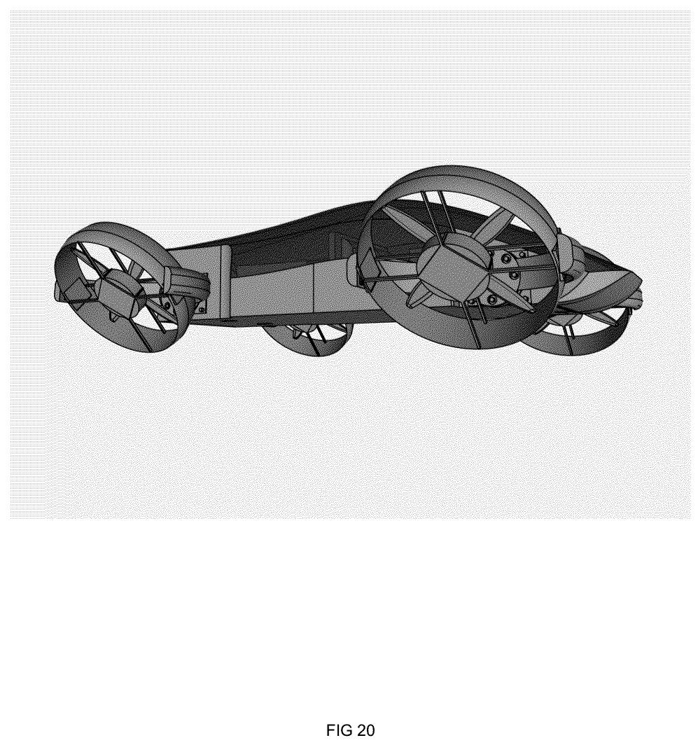

FIG. 20 This drawing is a rear view of a Vertical Aerial Vehicle that is utilizing this invention to achieve flight. The four lift modules of the system are postured to fly the aircraft rapidly to the left to perform a lateral sideline maneuver. The 45-degree side angle of the ducted propeller housings are determined by the pilots use of the input controls. The aircrafts starting displacement was a hover and maximum acceleration has been applied along with the sideline flight control without forward input & the aircraft flies laterally without applying roll, pitch or yaw to the body of the aircraft and while the aircraft maintains elevation. This maneuver is executed by an onboard input flight control & computer flight control system which takes speed, acceleration and obstacle avoidance information into consideration.

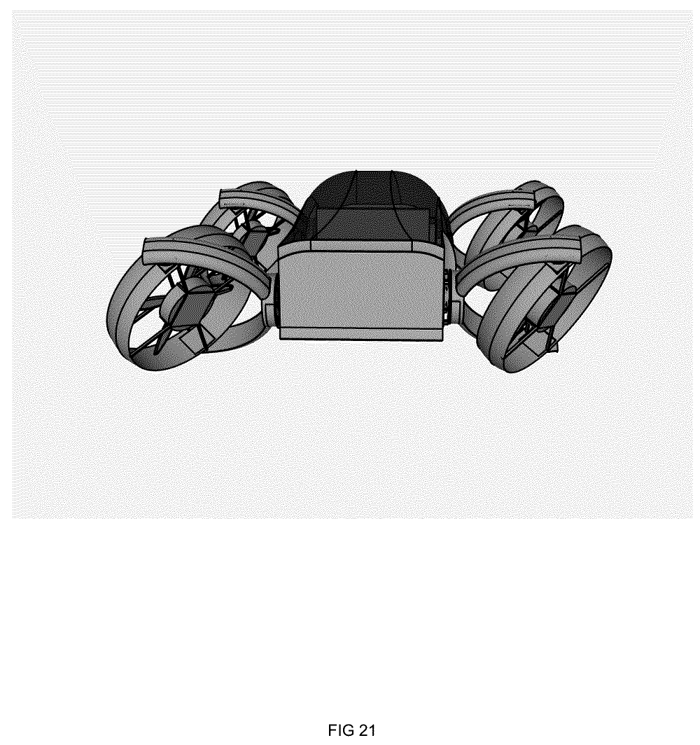

FIG. 21 This drawing is a rear view of a Vertical Aerial Vehicle that is utilizing this invention to achieve flight. The four lift modules of the system are postured to fly the aircraft rapidly forward & to the left to perform a lateral sideline maneuver while maintaining forward momentum. The 45-degree forward angle of the tilt wing arm and the 45-degree angle of the ducted propeller housings are determined by the pilots use of input controls. The aircrafts starting displacement was flying forward and maximum forward acceleration is being applied along with the left sideline flight control & the aircraft faces forward and flies at an angle without applying roll, pitch or yaw to the body of the aircraft allowing the aircraft to move laterally to the left while maintaining elevation and forward momentum similar to changing lanes on a freeway. The lift modules will maintain this position until the sideline input controls have been released, upon which the lateral rotating ducted housing will face forward until other input controls have been entered.

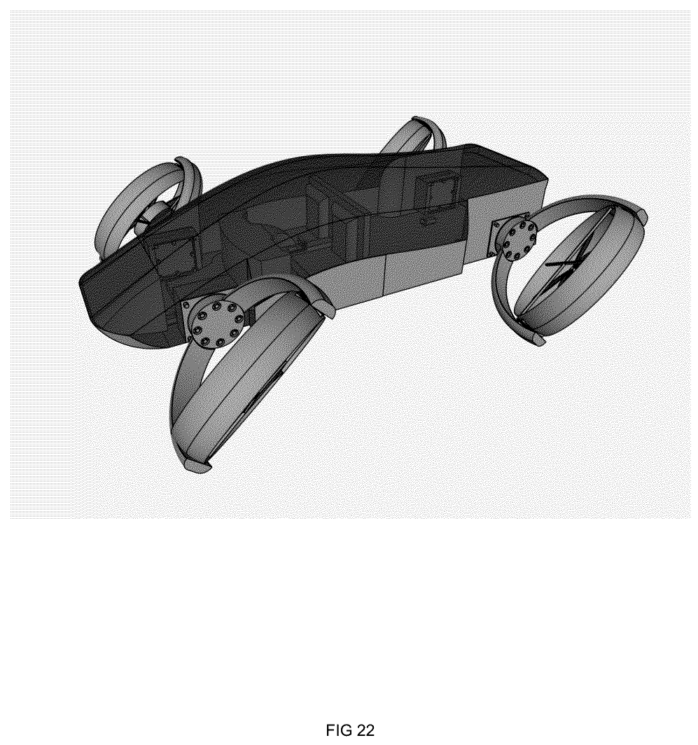

FIG. 22 This drawing is a side view of a Vertical Aerial Vehicle that is utilizing this invention to achieve flight. The four lift modules of the system are postured to fly the aircraft rapidly forward while also veering off to the right to perform a lateral sideline maneuver while maintaining forward momentum. The 45-degree forward angle of the tilt wing arm and the simultaneous 45-degree angle of the ducted propeller housings are determined by the pilot's use of the input controls. The aircrafts starting displacement was flying forward and maximum forward acceleration has been applied along with the sideline flight control & the aircraft flies forward and laterally, similar to a lane change on a freeway, without applying roll, pitch or yaw to the body of the aircraft allowing the aircraft to move laterally to the right while maintaining elevation and forward momentum. The lift modules will maintain this position until the sideline input controls have been released upon which the ducted housings will rotate to face forwards and the aircraft will continue to fly forwards and maintain elevation.

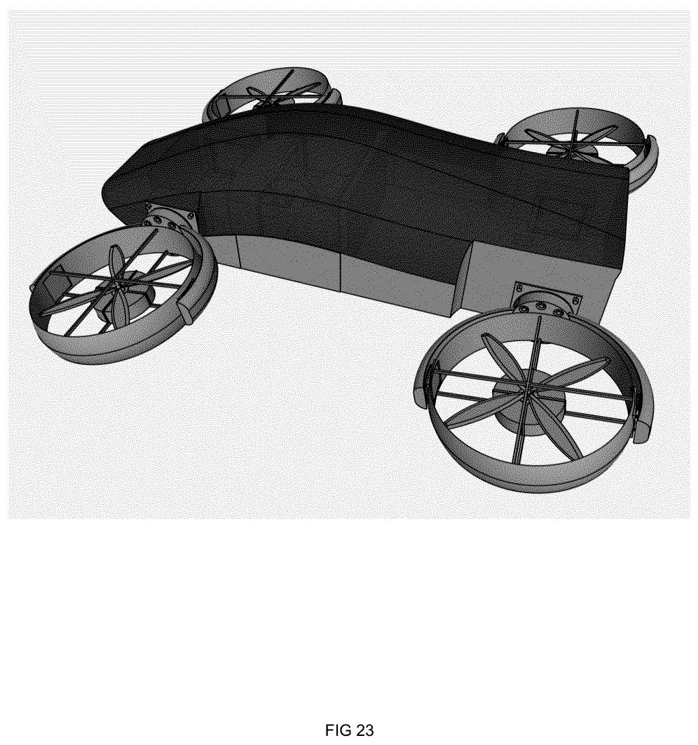

FIG. 23 The low forward pitch is determined by the pilot's use of acceleration and the current pitch of the lift modules is 10 degrees as the pilot is cruising the aircraft forward at a slow speed which is determined by applying slight acceleration.

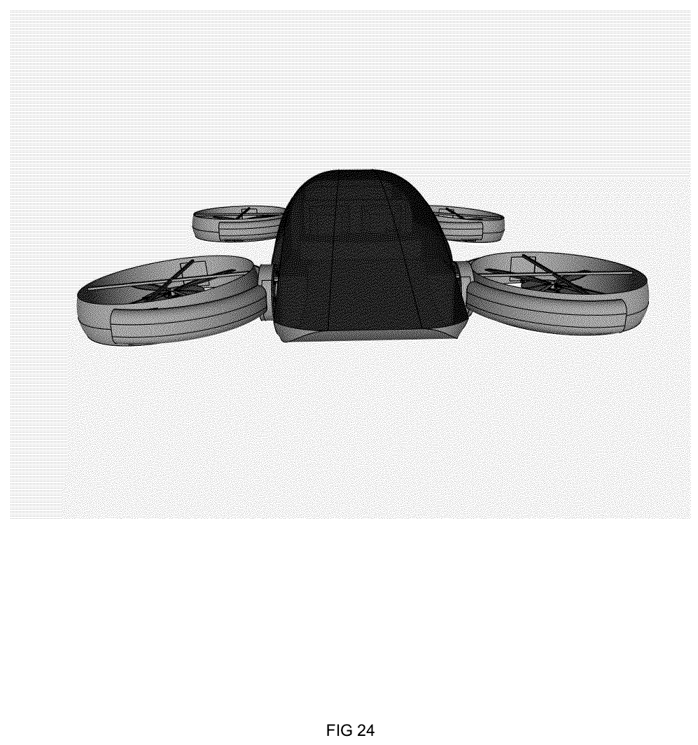

FIG. 24 This drawing is a front view of a Vertical Aerial Vehicle that is utilizing this invention to achieve flight. The four lift modules of the system are postured to rotate the aircraft while maintaining a hover and fixed position. The low pitch of front right and rear left lift module's is determined by the pilots of the input controls that turn the aircraft to the right. Multiple input control scenarios could be taking place to evoke this response of the aircraft. The aircraft could be in neutral, it could also be in forward with the brake applied or in reverse with brake applied as well. In all three scenarios the yoke is turned to the right part to mid-way, and this is useful for spinning the aircraft around to choose a takeoff position and there is an additional possibility to input controls. The Aircraft could be increasing or decreasing elevation as well. One final possibility is that the was already in motion and is moving in the direction of its momentum while now turning while hovering, ascending or descending. All could be possible scenarios given the current lift tilt configuration.

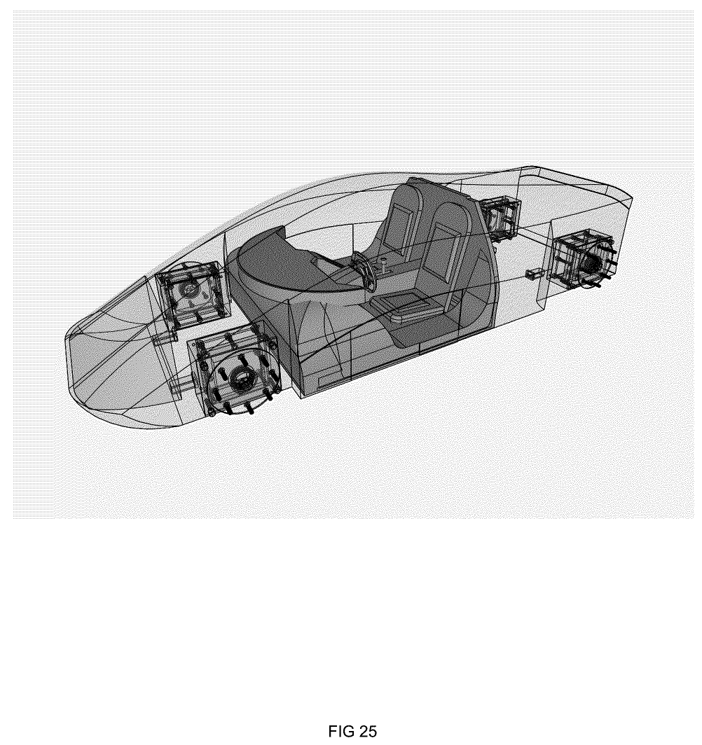

FIG. 25 Transparently pictured is a Vertical Aerial Vehicle with the lift modules lift modules removed to give a better idea of the modular aspect and how a lift module can be upgraded or worn parts can be replaced by removing the lug nuts and mounting the replacement parts or the replacement lift module.

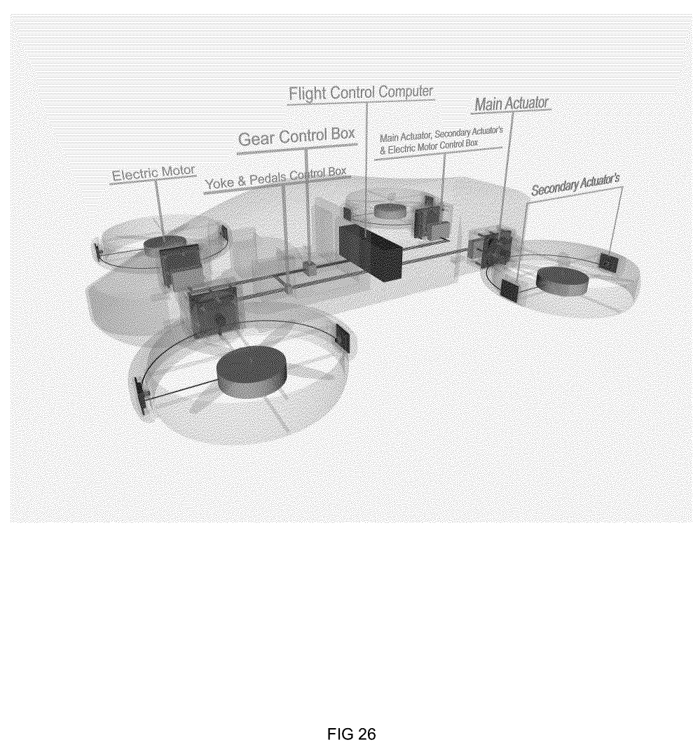

FIG. 26 This drawing offers a diagram of how the fly-by-wire system is utilized to control the electronic aspects of the lift modules. There is one Flight Control Computer, one Gear Control Box, one Yoke & Pedals Control Box, four of the “Main Actuator, Secondary Actuator's & Electric Motor Control” Boxes, four Main Actuators, four sets of two secondary actuators & four electric motors. The flight control computer sends preprogrammed commands to the four main actuator, secondary actuators and electric motor control boxes based on the inputs to the gear control box and the yoke and pedals control boxes. Those commands determine the speed of rotation of the electric motors and the degree and direction of tilt to each individual main actuator and to each set of secondary actuators which inadvertently determines the path the aircraft will take as it flies through the sky.

The present invention has been described in relation to a preferred embodiment and several alternative preferred embodiments. One of ordinary skill, after reading the foregoing specification, may be able to affect various other changes, alterations, and substitutions or equivalents thereof without departing from the concepts disclosed. It is therefore intended that the scope of the Letters Patent granted hereon be limited only by the definitions contained in the appended claims and equivalents thereof.

What is claimed is:

1. A manufacturing method comprising: an airframe with four lift points that each have a full set of the following;
an airframe adapter; and
an electromagnetic actuator; and
a set of eight lug nuts; and
a set of eight bolts; and
a lift hub assembly; and
a set of four bolts; and
a tilt-wing arm; and
a set of eight lug nuts; and
a set of small electromagnetic actuators; and
a set of small lift hub assemblies; and
a left set of four bolts; and
a right set of four bolts; and
a left set of eight lug nuts; and
a right set of eight lug nuts; and
a ducted prop housing; and
an axial flux motor; and
a mounting bracket; and
a propeller; and
a fly-by-wire, wire harness.

2. A manufacturing method comprising: four independent identical lift points that each have two perpendicular interconnected electromagnetically powered rapidly rotating points that rotate on tapered bearing hub assemblies called lift hub assemblies that enable a propeller to rapidly face any direction 360 degrees laterally with up to 88 degrees of tilt where one jointed point mounted to the airframe rapidly rotates a C-shaped arm, which is mounted on a large lift hub assembly, up to 88 degrees forward or backward in less than one second and secondary jointed points on two smaller lift hub assemblies that hold a ducted housing that is rapidly tilted to the left or right simultaneously to provide rapid control of the exact direction of the thrust wherein the four lift points thrust in a synchronized or non-synchronized manner with respect to one another to achieve a new wing manipulation that enables rapid precise high-performance aerial directional movements.

3. A manufacturing method comprising: four independent lift points that provide roll to turn the aircraft eliminating the need for the airframe to roll.

4. A manufacturing method comprising: a mountable electromechanical part called a lift module, that contains an electric powered propeller or other means of creating lift that is specifically removeable, mountable and upgradable to provide a modular method to building an aircraft.

5. A manufacturing method comprising: an aircraft body that has 4 or more evenly distributed mounting points for mounting two-way tilt lift modules to be mounted on the sides of the aircraft body in a four point, or greater evenly distributed, lift configuration that form a new type of aircraft called the Vertical Aerial Vehicle.

6. A manufacturing method comprising: four or more independent hub assemblies called lift hub assemblies used to support a respective number of lift points that when combined with the hub assembly's capability to rotate the lift point forwards and backwards give's advanced directional control of an aircraft.

7. A manufacturing method as in claim 1, wherein full a set of parts listed are fastened to one another in the order listed to complete a single lift point called a Lift Module.

8. A manufacturing method as in claim 1, wherein the fly-by-wire or equivalent wire harness is channeled through the lift point tunnel to provide power to all the electric components.

9. A manufacturing method as in claim 2, wherein the airframe can rapidly fly forwards and backwards, left and right, up and down and at any angle between without rolling or pitching the airframe.

10. A manufacturing method as in claim 2, wherein the airframe can achieve yaw by desynchronizing the tilt of the lift points to rapidly spin the aircraft.

11. A manufacturing method as in claim 3, wherein the lift points provide roll to allow the aircraft to fly sideways without body roll being applied to the airframe.

12. A manufacturing method as in claim 4, wherein an upgrade to the lift modules can provide greater performance, specialized lift capabilities or increased capacity.

13. A manufacturing method as in claim 6, wherein four or more independent hub assemblies are mounted to the side of an airframe or to an extension of the airframe to provide a mounting point for forward and reverse tiltable lift modules.

14. A manufacturing method as in claim 9, wherein the rotation of each lift hub assembly is achieved by use of a rapid motion electromagnetic actuator or motor that has a limited throw of anywhere from 90 degrees to 176 degrees 45 in either direction or up to 88 in either direction respectively.
